(19) United States
(12) Patent Application Publication
(10) Pub. No.: US 2005/0192848 A1
(43) Pub. Date: Sep. 1, 2005

(54) Method and apparatus for automated post-discharge follow-up of medical patients

(75) Inventors: Andrew S. Kozminski, Ottawa (CA); Alan Forster, Gatineau (CA); Gary Hannah, Manotick (CA)

Correspondence Address: OGILVY RENAULT LLP, 1981 MCGILL COLLEGE AVENUE, SUITE 1600, MONTREAL, QC, H3A2Y3, CA

(73) Assignee: VOCANTAS INC., Ottawa (CA)

(21) Appl. No.: 11/063,845

(22) Filed: Feb. 23, 2005

Related U.S. Application Data
(60) Provisional application No. 60/547,438, filed on Feb. 26, 2004.

(51) Int. Cl. G06F 17/60

(52) U.S. Cl. 705/3

(57) ABSTRACT

An automated system for post-discharge follow-up of discharged patients automatically contacts each discharged patient after a predetermined period of time. The discharged patient is presented with a series of questions and an answer to each question is collected and analyzed. If the analysis detects an anomaly, an alert message is sent to a predetermined contact person to permit an investigation to be conducted.

### CROSS-REFERENCE TO RELATED APPLICATIONS

This application claims the benefit of priority under 35 U.S.C. §119(e) to U.S. Provisional Patent Application Ser. No. 60/547,438 filed Feb. 26, 2004.

### MICROFICHE APPENDIX

Not Applicable.

### TECHNICAL FIELD

This application relates in general to the provision of healthcare services and, in particular, to the post-discharge follow-up of selected patients discharged from a medical care facility.

### BACKGROUND OF THE INVENTION

It is well known that the risk of experiencing adverse events following discharge from a medical care facility is considerable. It is also well known that it is highly advisable to contact patients after discharge from a medical care facility to ensure that any adverse events are detected early. It is also believed to be desirable to document and record adverse events experienced subsequent to discharge from a medical care facility, in order to gather information that is potentially valuable for reducing post-discharge complications by analyzing post-discharge data to determine which medical procedures gave rise to a highest incidence of post-discharge trauma.

While it is widely accepted that the follow-up of patients discharged from a medical care facility is beneficial, shrinking health budgets and service cutbacks mean that most modern medical care facilities cannot follow-up with every patient, much less take the time to guide each patient through a series of questions needed to collect information about their post-discharge condition. Consequently, there is a long felt need for an automated system that can autonomously and automatically follow-up with patients recently discharged from a medical care facility.

### SUMMARY OF THE INVENTION

It is therefore an object of the invention to provide an automated system that can autonomously and automatically follow-up with patients recently discharged from a medical care facility.

In accordance with one aspect of the invention, there is provided a system for automated post-discharge follow-up of discharged patients, comprising: a system control processor having an interface for obtaining discharge information related to each of the discharged patients; communications equipment controlled by the system control processor to establish communications with a discharged patient and to present the discharged patient with a plurality of questions about their post-discharge status and gather answers to the questions from the discharged patient; and a messaging system controlled by the system control processor for generating an alert message sent to a predetermined contact person if the system control processor determines that given the answers gathered from the discharged patient an alert message should be sent.

In accordance with another aspect of the invention, there is provided a method for the post-discharge follow-up of discharged patients, comprising: accessing discharged patient contact preference information and a discharge time for each discharged patient to be followed up; determining when discharge follow-up is to occur using the discharge time to compute a discharge follow-up time; automatically establishing a communications session with the discharged patient after the discharge follow-up time; presenting the discharged patient or a primary care giver of the discharged patient with a series of predetermined questions respecting a status of the discharged patient; collecting an answer for each question presented; analyzing the answers to determine whether an alert message to a predetermined contact person should be generated; and generating the alert message and forwarding the alert message to the predetermined contact person if the analysis indicates that the alert message should be sent.

### BRIEF DESCRIPTION OF THE DRAWINGS

Further features and advantages of the present invention will become apparent from the following detailed description, taken in combination with the appended drawings, in which:

FIG. 1 is a schematic diagram of an embodiment of a system in accordance with the invention;

FIG. 2 is a flowchart of an overview of a process in accordance with the invention for the automated follow-up of post-discharge patients;

FIG. 3 is a flowchart illustrating principle steps of a method of contacting post-discharge patients in accordance with the invention; and

FIG. 4 is a flowchart illustrating an analysis of post-discharge data in accordance with an embodiment of the invention.

It will be noted that throughout the appended drawings, like features are identified by like reference numerals.

### DETAILED DESCRIPTION OF THE PREFERRED EMBODIMENT

The present invention provides an automated system for the follow-up of post-discharge patients for the purpose of early determination of post-discharge adverse events. The system in accordance with the invention includes an interface for accessing patient discharge data to determine when discharged patients should be contacted. An autonomous, automated contact system contacts discharged patients a predetermined time after discharge and presents a set of predetermined questions to the discharged patient in order to detect adverse events. If the system is unable to contact the patient or determines that the patient has experienced an adverse event, the system sends an alert message to a designated contact person, who performs a manual follow-up to determine an extent of the adverse event, and to take appropriate action. The system in accordance with the invention is entirely autonomous and automated. If the post-discharge patient requests a voice call, a voice session is established through the Public Switch Telephone Network (PSTN) or a Voice over Internet Protocol (VoIP) session is established between the patient and a speech server. The speech server is controlled to present a predetermined set of questions to the discharged patient. Responses to the questions are collected and subsequently analyzed. Post-discharge statistics are kept to permit analysis to determine the frequency of post-discharge adverse events, as well as to determine those procedures that most often result in post-discharge adverse events.

System Overview

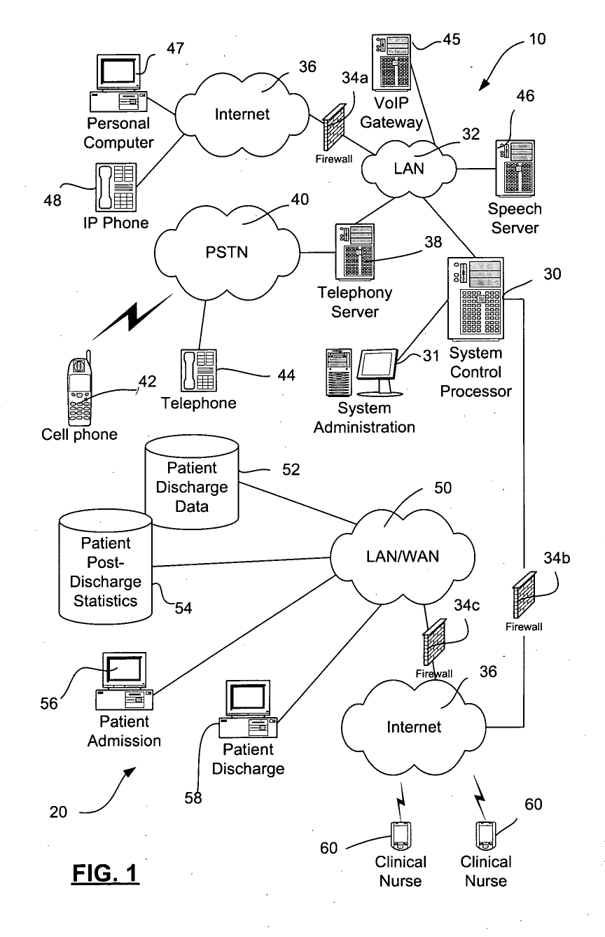

FIG. 1 is a schematic diagram of an embodiment of a system 10 in accordance with the invention. System 10 includes a system control processor 30 provided with a system administration workstation 31 which permits a system administrator to monitor and update programs executed by the system control processor 30, as required. The system control processor 30 is connected, for example, to a Local Area Network (LAN) 32, which is likewise connected through a firewall 34a to the internet 36. The LAN 32 is likewise connected to a telephony server 38, which is in turn connected to the Public Switch Telephone Network (PSTN) 40.

The PSTN 40 serves a plurality of subscribers, such as a cellular telephone subscriber 42 and a wire line telephone subscriber 44. Also connected to the LAN 32 is a voice over internet protocol (VoIP) server 45 and a speech server 46, both of which are well known in the art. The speech server 46 provides speech services for voice connections established through the PSTN 40 or the internet 36. Voice sessions established through the internet 36 are completed, for example, to an IP phone 48. Text messages, such as email messages, instant messages or short message service messages (SMS) may likewise be sent through the internet 36 to personal computer 47. Although the telephony server 38, VoIP server 45 and speech server 46 are shown as separate logical entities, as will be understood by persons skilled in the art each of these servers may be implemented on one computer, and may be implemented on the system control processor 30.

The system 10 may further include a worldwide web (WWW) server 49 connected to the internet 36. The WWW server 49 permits discharged patients to elect an option of a personal worldwide web page for completing a post-discharge questionnaire. The personalized worldwide web pages can be automatically generated for each discharged patient using methods well known in the art. If this option is elected, the patient is presented with a Universal Resource Locator that points to their personal worldwide web page on discharge, along with instructions about when to complete the post-discharge questionnaire presented on the personal worldwide web page.

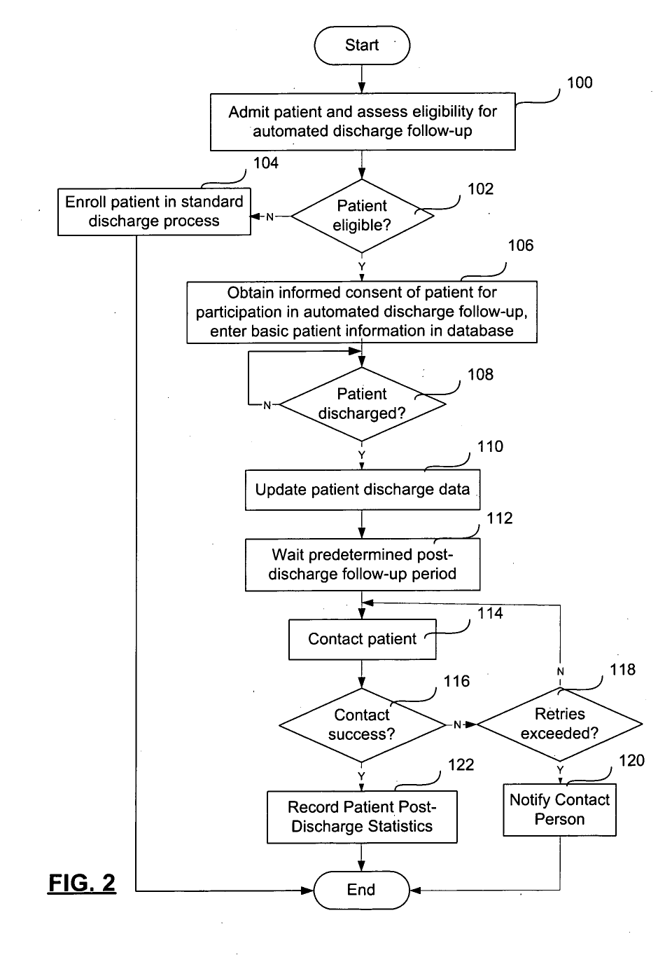

The system 10 in accordance with the invention has access to patient discharge data stored in the patient discharge database 52. The patient discharge database 52 may be, for example, maintained by a hospital campus 20, and may be part of or incorporated in a general patient database. The hospital campus 20 is equipped with a Local/Wide Area Network (LAN/WAN) 50. The hospital campus 20 has an admission department that enters patient data in the patient discharge data database 52 using a patient admission workstation 56. Hospital campus 20 likewise includes a patient discharge department, which enters further information in the patient discharge database 52 using a patient discharge workstation 58. The hospital campus 20 has a connection to the internet 36 protected by a firewall 34c. Clinical nurses using wireless data devices 60 send and receive information through the internet 36, as will be explained below in more detail. In this embodiment, the system control processor 30 accesses patient discharge data through the internet 36 and the LAN/WAN 50 via firewalls 34b, 34c, in a manner well known in the art. The system control processor 30 likewise stores patient post-discharge statistics in database 54, as will also be explained below in more detail with reference to FIGS. 2-4.

General Process Overview

FIG. 2 is a flowchart that provides an overview of steps in a method in accordance with the invention. In step 100, a patient is admitted and assessed for eligibility for automated discharge follow-up. The eligibility assessment may include a determination of whether the patient speaks a language compatible with the system 10; has a working communications device that may be used by the system 10 to conduct the automated follow-up; and, whether the patient is cognitively intact or has a primary care giver that is cognitively intact. Other criteria may also be used.

If it is determined in step 102 that the patient is not eligible for automated discharge follow-up, the patient is enrolled in a standard discharge process (step 104) and the process ends. If, however it is determined in step 102 that the patient is eligible for the program, the automated discharge follow-up is explained to the patient, an informed consent for participation is obtained from the patient, and basic patient information is entered in the patient discharge database 52 (step 106). This database is accessed periodically by the system control processor 30, for example, by periodically querying of the patient database 52 to retrieve records that meet a given criteria, such as a specified discharge date. Alternatively, the patient discharge database 52 may be programmed to send notifications to the system control processor 30 in a manner well known in the art.

When a patient is discharged, hospital staff using the patient discharge workstation 58 update the patient discharge database to insert a discharge date and time (step 110). This is detected by querying or receipt of a notification, as explained above, by the system control processor 30 which waits a predetermined post-discharge follow-up period before attempting to establish contact with the discharged patient (step 112). In step 114, the system control processor 30 uses information obtained from the patient discharge database 52 to contact the patient. That information may include a preferred means of contact as well as any required contact numbers or addresses. In any event, the system control processor 30 attempts to contact a patient (step 114) using the preferred communications medium.

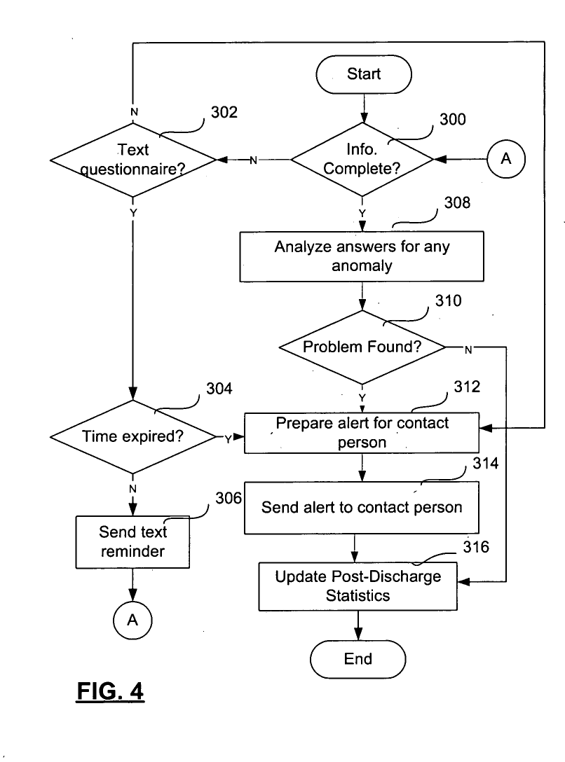

In step 116 it is determined whether the contact was successful, for example, whether a voice connection was established with the discharged patient. If not, the system control processor 30 retries until a number of retries has been exceeded or a retry time period has elapsed (step 118). Periodic attempts to contact the discharged patient continue until contact is successful or the retry period elapses. If the discharged patient cannot be contacted within the predefined limits, a predetermined contact person is notified in step 120, for example, a clinical nurse. This notification is effected by sending an alert message sent in an email notification, an instant message or a short message service (SMS) notification via the internet 36 to a wireless device 60 operated by the clinical nurse responsible for the patient. If, on the other hand, the patient is successfully contacted, a series of questions are presented to determine the discharged patient's status, and the patient's answers are recorded to permit an analysis. Results of the analysis are recorded in the patient post-discharge statistics database 54. After the results are analyzed any required alert messages are sent, as will be explained below with reference to FIG. 4.

In accordance with one embodiment of the invention, the questions presented to the discharged patient are structured to require only a “yes” or a “no” response. In another embodiment, responses are gathered using dual-tone modulated frequency (DTMF) tones generated by the discharged patient or primary care giver manipulating a telephone keypad. The number of questions and the expected responses are a matter of design choice, and the number and type of questions can be tailored in any desired way, including being category of pre-discharge procedure dependent. Extensive experimentation has determined that it is advisable to determine at least the following: has the discharged patent experienced new or worsening health problems; if new or worsening problems were experienced, how severe are those problems; has the discharged patient had any suspected problems with medication; has the patient had any difficulty contacting their family physician; does the patient wish to be contacted by hospital staff.

Discharged Patient Contact Process

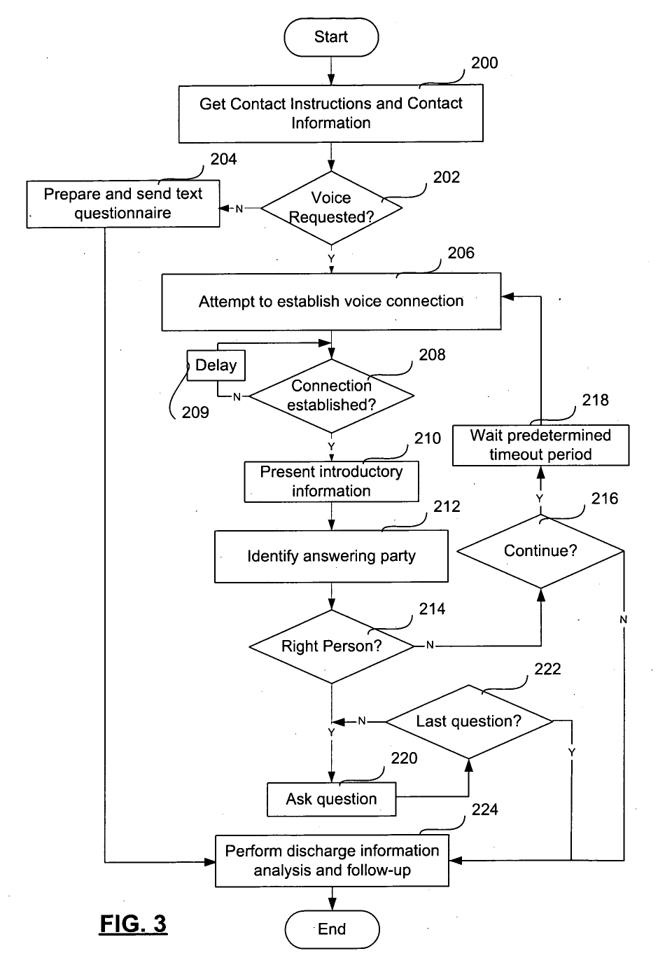

FIG. 3 is a flowchart detailing principle steps in the patient contact process performed by the system control processor 30 when information in the patient discharge database 52 indicates that a patient should be contacted. In step 200, the system control processor 30 gets contact preferences and contact information as explained above either by querying the patient discharge database 52, or by receiving notifications containing patient discharge data sent form the patient discharge database 52. In step 202 the system control processor 30 determines a type of contact requested by the patient. For example, a patient may request voice contact through a PSTN call or VoIP session, or may request a personal worldwide web page that presents a questionnaire that they can complete on their own a predetermined time after discharge, or a text questionnaire sent via email.

If voice contact was not requested, as determined in step 202, it is determined in step 203 whether the patient requested a personal worldwide web page. If so, the patient was provided at discharge with an information sheet containing a Universal Resource Locator (URL) that points to their personal web page and instructions concerning when to complete a questionnaire available on their personal web page and, optionally, how to complete the questionnaire.

If neither voice contact nor a web page was requested, the patient has requested a text questionnaire delivered by email. Consequently, the text questionnaire is prepared in step 204 and sent to the patient by the system control processor 30 via the internet 36. The worldwide web page is accessed, or the text questionnaire is received, for example, by the personal computer 47 operated by the discharged patient.

At the instructed time, the discharged patient is expected to complete the questionnaire on the personal web page, or the questionnaire sent in the email message, and to return it to the system control processor 30. In step 205, it is determined whether the discharged patient's questionnaire has been received, regardless of the medium (web interface or email) used to complete it. If the completed questionnaire has been received, as determined in step 205, the system control processor 30 analyzes the answers and takes required steps, including storing patient post-discharge statistics in the database 54 (step 224). If the completed questionnaire has not been received, a reminder is sent (step 207) by one or more of email, instant message, or short message service, for example, and the system control processor waits a predetermined period of time before checking again for receipt of the response. This process may time out after a predetermined time, as will be explained below with reference to voice contacts.

If a voice contact is requested, as determined in step 202, the system control processor 30 attempts to establish a voice connection. The voice connection may be established in either of two ways. For example, the system control processor 30 may control a telephony server 38 to establish a dial-up connection through PSTN 40 to the wire line telephone 44 or the cellular phone 42 owned by the patient. Alternatively, a VoIP session may be established to an IP telephone 48 using methods well known in the art. In either instance, the speech server 46 is employed to interact with the patient.

In step 208 it is determined whether voice contact has been established. If not, a retry is attempted after a predetermined delay 209. As explained above with reference to FIG. 2, if voice contact with the discharged patient cannot be established after a predetermined number of attempts or a predetermined time interval has elapsed, notification is sent to the designated contact person to report the problem. If voice contact is established, the speech server 46 is prompted to present introductory information reminding the discharged patient or a primary care giver of the discharged patient about the automatic follow-up consented to and requesting that the answering party identify themself (step 212). If the answering party is not the discharged patient or the primary care giver, as determined in step 214, the speech server 46 is directed to ask the answering person whether a further attempt should be made to contact one of the discharged patient and the primary care giver. If the person who answers indicates that the system should continue in its attempts to reach the discharged patient or the primary care giver, the system control processor 30 waits a predetermined time (step 218) before re-attempting to establish a voice connection/session in step 206. Otherwise, the system control processor 30 proceeds to step 224 and performs discharge information analysis and follow-up as will be explained below in more detail with reference to FIG. 4.

If is determined in step 214 that the party who answers is the discharged patient or the primary care giver of the discharged patient, the system control processor 30 directs the speech server to ask a first question (step 220). Once an answer is collected (step 221) and the speech server 46 advises the system control processor 30 that the party has answered the question. The system control processor 30 determines in step 222 whether the last question has been asked. If not, it directs the speech server 46 to ask the next question and awaits confirmation that a response to the question has been received. This process reiterates until a response to a last question has been received, or the call is terminated by the called party. When the speech server 46 notifies the system control processor 30 that a response to the last question has been received, the system control processor 30 releases the voice session and performs discharge information analysis and follow-up (step 224) as will be explained below with reference to FIG. 4.

Information Analysis and Follow-Up

FIG. 4 is a flowchart showing principle steps involved in the discharge information analysis and follow-up (step 224 of FIG. 3). In step 300, the system control processor 30 determines whether the information received is complete, i.e. whether all questions were answered and, in the case of a text questionnaire, whether a response has been received and is correctly completed. If not, the system control processor 30 determines in step 302 whether the patient was contacted using a voice connection/session or was provided with a text questionnaire using any one of the methods described above, i.e. a personalized web page, an instant message service, or an electronic mail service. If a text questionnaire was the mode of contact, it is determined in step 304 whether the time allotted for a response has expired. If not, a text reminder is sent, for example, via one or more of instant messaging, short message service (SMS) or email in step 306 and the process returns to step 300.

If the information received is complete, the system control processor 30 analyzes the answers received for any anomaly. In accordance with one embodiment, if any of the questions asked of the patient or the primary care giver deviates from an expected response, an anomaly is detected. This is, of course, a matter of design choice and whether an anomaly is detected depends on how the survey is structured, as will be understood by those skilled in the art. If no anomaly is found in step 310, the post-discharge statistics database 54 is updated in step 316 and the process ends. If an anomaly is detected, an alert message is generated and addressed to the predetermined contact person (e.g. the clinical nurse) (step 312). The alert message may be an instant message, a short message service message or an email message. In step 314 the alert message is sent to the contact person, e.g., to the wireless device 60 shown in FIG. 1. The system control processor 30 then updates the post-discharge statistics in step 316 and the process is complete.

Thereafter, the post-discharge statistics may be queried and analyzed to determine a frequency of post-discharge adverse events, and to correlate those events with specific pre-discharge procedures in order to improve pre-discharge care to reduce post-discharge adverse events.

Although the system has been explained above with particular reference to hospital patients, it will be well understood by those skilled in the art that the system has much broader application and may be used, for example, to follow-up with patients who have undergone walk-in treatments such as dental surgery, outpatient surgery, plastic surgery and other invasive procedures that require follow-up to determine whether a patient is experiencing a post-procedure adverse event.

The embodiments of the invention described above are intended to be exemplary only. The scope of the invention is therefore intended to be limited solely by the scope of the appended claims.

1. A system for automated post-discharge follow-up of discharged patients, comprising:
a system control processor having an interface for obtaining discharge information related to each of the discharged patients;
communications equipment controlled by the system control processor to establish communications with a discharged patient and to present the discharged patient with a plurality of questions about their post-discharge status and gather answers to the questions from the discharged patient; and
a messaging system controlled by the system control processor for generating an alert message sent to a predetermined contact person if the system control processor determines that given the answers gathered from the discharged patient an alert message should be sent.

2. The system as claimed in claim 1 wherein the interface for obtaining discharge information comprises a database query that permits the system control processor to retrieve information from a patient discharge database.

3. The system as claimed in claim 1 wherein the interface for obtaining discharge information comprises notifications sent by a patient discharge database to the system control processor.

4. The system as claimed in claim 1 wherein the communications equipment controlled by the system control processor to establish communications with the discharged patient comprises a telephony server used to establish a voice connection through the public switched telephone network, and a speech server used to present the questions to the discharged patient and receive answers from the discharged patient.

5. The system as claimed in claim 1 wherein the communications equipment controlled by the system control processor to establish communications with a discharged patient comprises a voice over internet protocol server for establishing a voice session through the internet, and a speech server used to present the questions to the discharged patient and receive answers from the discharged patient.

6. The system as claimed in claim 1 wherein the communications equipment controlled by the system control processor to establish communications with a discharged patient comprises at least one of a web server for providing a personalized web page for the discharged patient, an email service for sending a text questionnaire to the discharged patient, and an instant message service for sending the text questionnaire to the discharged patient.

7. The system as claimed in claim 1 wherein the messaging system controlled by the system control processor to generate an alert message comprises at least one of an email system, and instant message service, and a short message service.

8. The system as claimed in claim 1 further comprising an interface for updating a patient post-discharge statistics database for storing information gathered by the system control processor about discharged patients.

9. A method for the post-discharge follow-up of discharged patients, comprising:
accessing discharged patient contact preference information and a discharge time for each discharged patient to be followed up;
determining when discharge follow-up is to occur using the discharge time to compute a discharge follow-up time;
automatically communicating with the discharged patient after the discharge follow-up time to present the discharged patient or a primary care giver of the discharged patient with a series of predetermined questions respecting a status of the discharged patient;
collecting answers for each of the questions presented;
analyzing the answers to determine whether an alert message to a predetermined contact person should be generated; and
generating the alert message and forwarding the alert message to the predetermined contact person if the analysis indicates that the alert message should be sent.

10. The method as claimed in claim 9 wherein accessing discharged patient information comprises querying a patient discharge database to retrieve information related to patients discharged during a pre-selected time interval.

11. The method as claimed in claim 9 wherein accessing discharged patient information comprises receiving notifications sent from a patient discharge database, the notifications containing the patient contact preference information and the discharge time for each patient.

12. The method as claimed in claim 9 wherein automatically communicating with the discharged patient comprises automatically establishing a voice communications session with the discharged patient.

13. The method as claimed in claim 12 wherein establishing the voice communications session comprises establishing a dial-up connection through the public switched telephone network to a telephone associated with the discharged patient.

14. The method as claimed in claim 12 wherein establishing the voice communications session comprises establishing a voice over internet protocol session with an internet protocol phone associated with the discharged patient.

15. The method as claimed in claim 13 wherein presenting the discharged patient or a primary care giver of the discharged patient with a series of predetermined questions comprises prompting a speech server to orally present each question and to wait for a response from the discharged patient or the primary care giver.

16. The method as claimed in claim 14 wherein presenting the discharged patient or a primary care giver of the discharged patient with a series of predetermined questions comprises prompting a speech server to orally present each question and to wait for a response from the discharged patient or the primary care giver.

17. The method as claimed in claim 9 wherein automatically communicating with the discharged patient comprises at least one of: automatically generating and making available a personal worldwide web page to the discharged patient; automatically generating and sending an electronic mail questionnaire to the discharged patient; automatically generating and sending to the discharged patient a text questionnaire using an instant messaging service.

18. The method as claimed in claim 9 wherein analyzing the answers comprises comparing each answer with a preferred answer and generating the alert message if any answer does not conform to the preferred answer.

19. The method as claimed in claim 18 wherein generating the alert message comprises generating at least one of an instant message, a short message service message, and an email message that is sent to the predetermined contact person.

20. A product comprising a computer readable memory and computer executable program instructions stored in the memory for performing the method claimed in claim 9.
